(19) United States
(12) Patent Application Publication
(10) Pub. No.: US 2007/0157633 A1
(43) Pub. Date: Jul. 12, 2007

(54) LN2 maintenance system

(75) Inventors: Gus W. Cutting, Palm Harbor, FL (US); Nicholas A. Hartney, St. Peterburg, FL (US); Winston S. Webb, Largo, FL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/328,670

(22) Filed: Jan. 10, 2006

(51) Int. Cl. F17C 13/02

(52) U.S. Cl. 62/49.1

(57) ABSTRACT

A LN₂ maintenance system is provided. The maintenance system includes an input sensor and a solenoid. The input sensor is adapted to monitor the temperature of the medium in an input tube to a device using the LN₂. The solenoid is adapted bleed off the medium based on the monitored temperatures.

### BACKGROUND

Liquid nitrogen (LN₂) is used for many applications in industry because of its thermal characteristics. In large systems, the LN₂ is usually sourced from a large reservoir located far away from the device that uses the LN₂. One problem with this delivery method is that the LN₂ can begin to boil off in the delivery lines. Even with vacuum jacket lines, if the line is not used often, the LN₂ will begin to boil off in the line and turn to gas nitrogen (GN₂). Moreover, the last few feet of lines carrying the LN₂ into the device are typically plumbed with copper tube that is at room temperature. At room temperature LN₂ will boil off into GN₂ in a relatively rapid fashion.

Because of this boiling off of the LN₂, when a device requests a flow of LN₂ all the GN₂ in the supply lines must first be vented off before the flow of LN₂ can be delivered. In systems that use LN₂ for process control, such as fluids carts or chambers, the delay caused by the required venting of the GN₂ can cause major temperature oscillations resulting in unacceptable performance. In addition, waiting for the LN₂ to arrive can add up to twenty minutes per cycle resulting in added cycle time and more cost.

For the reasons stated above and for other reasons stated below which will become apparent to those skilled in the art upon reading and understanding the present specification, there is a need in the art for a an efficient and effective system and method of removing or preventing GN₂ in an LN₂ delivery system.

### SUMMARY OF INVENTION

The above-mentioned problems of current systems are addressed by embodiments of the present invention and will be understood by reading and studying the following specification.

In one embodiment, an LN₂maintenance system is provided. The maintenance system includes an input sensor and a solenoid. The input sensor is adapted to monitor the temperature of the medium in an input tube to a device using the LN₂. The solenoid is adapted bleed off the medium based on the monitored temperatures.

In another embodiment, a liquid nitrogen (LN₂) system is provided. The system comprises an input tube, an input sensor, and a solenoid. The input tube is used to provide a flow of LN₂ to a device. The input sensor is adapted to measure the temperature in the input tube. The solenoid is adapted to selectively bleed off a medium in the input tube during idle periods of the device based on the measured temperatures.

In yet another embodiment, a method of maintaining a supply of a medium in a first state is provided. The method includes measuring the temperature of the medium in an input tube. Comparing the measured temperature with a reference temperature and when the measured temperature is above the reference temperature, bleeding off the medium in the input tube.

In still another embodiment, a liquid nitrogen (LN2) maintenance system is provided. The system includes a means to automatically bleed off gas nitrogen (GN2) in an input tube during idle periods of a device using the LN₂ so that LN2 is available relatively instantaneously upon activation of the process control chamber.

### BRIEF DESCRIPTION OF THE DRAWINGS

The present invention can be more easily understood and further advantages and uses thereof more readily apparent, when considered in view of the description of the preferred embodiments and the following figures in which:

FIG. 1 is an illustration of a LN₂ system of the present invention; and

FIG. 2 is a flow chart illustrating one method of an embodiment of the present invention.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims and equivalents thereof.

Embodiments of the present invention provide an efficient and effective method of providing LN₂ to system. In particular, in embodiments of the present invention, a small amount of LN₂ and/or GN₂ is automatically bled off during idle periods so that GN₂ does not have time to build up in an input tube. By doing this, LN₂ is available immediately when requested in the chamber.

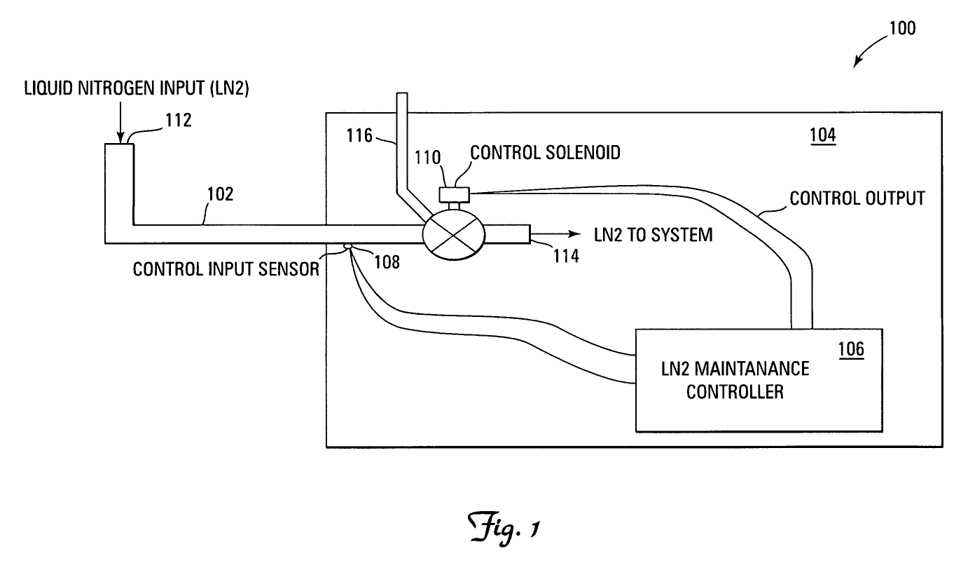

Referring to FIG. 1, an illustration of a LN₂ system 100 of one embodiment of the present invention is provided. As illustrated, FIG. 1 includes a chamber 104 for process control. An input tube 102 is used to plumb LN₂ into the chamber 104. In one embodiment, the input tube is a copper tube having an input 112 to receive a flow of LN₂ from vacuum jacket lines (not shown) and an output 114 to output the flow of LN₂ to the chamber 104. The LN₂ system includes a LN₂ maintenance system. The maintenance system includes a control input sensor 108, a controller 106 and a solenoid 110. The control input sensor 108 is in contact with input tube 102. The control input sensor 108 measures the temperature of the medium (gas or liquid) in the input tube 102. The control input sensor 108 is in communication with the controller 106. The controller 106 is coupled to the solenoid 110. The solenoid 110 selectively bleeds GN₂ from the input tube 102 under the control of the controller 106 when the system is idle. In particular, the controller 106 activates the solenoid 110 to bleed of the medium (LN₂ or GN₂) in the input tube 102 when the input sensor 108 senses a temperature that indicates a gas is in the input tube 102. In one embodiment, the medium is bleed off through and exhaust tube 116. In another embodiment, the medium is simply bled off into the chamber 104. The heaters in the chamber 104 can easily overcome the effects of the medium during its hot dwell. This embodiment allows for fewer moving parts and allows the system to be retrofitted to existing systems. Moreover, in an embodiment in which the medium is bled off into the chamber, the medium can be used to cool the chamber off by bleeding off small amounts of the medium.

The LN₂ system described above in relation to a chamber 104 is made by way of example and not be limitation. Many different types of devices that use LN₂ can utilize embodiments of the LN₂ maintenance system of the present invention. Another example is a fluid chiller where the LN₂ conditions a fluid that is circulated in a closed loop.

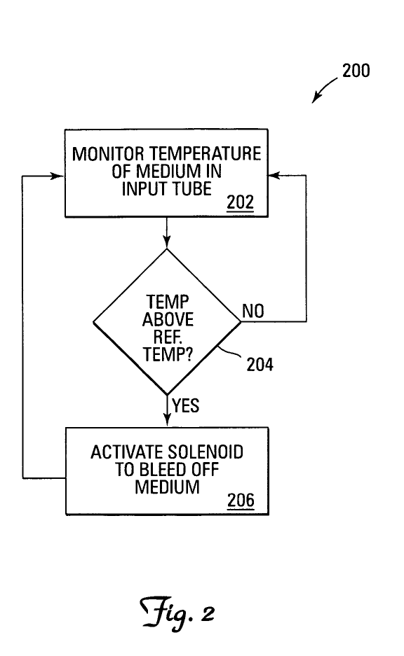

Referring to FIG. 2, a flow chart 200 illustrating one method of the present invention is provided. As illustrated in FIG. 2, the process starts by monitoring the temperature of the medium in the input tube (202). In embodiments of the present invention this is done with an input sensor 108 that is coupled to measure the temperature of the medium in the input tube 102. In one embodiment, the input sensor 108 is simply in thermal communication with a portion of the input tube 108. In another embodiment, the input sensor 108 is in direct thermal contact with the medium in the input tube 108.

Temperatures sensed by the input sensor 108 are compared by the controller 106 to a stored reference temperature (204). In embodiments of the present invention, the reference temperature is selected to ensure gas will not build up in the input tube 102. In one embodiment, the reference temperature is the temperature in which a liquid changes to a gas. In another embodiment, the reference temperature is a temperature near the temperature in which the liquid changes to a gas. If a sensed temperature is below the reference temperature (204), the input sensor 108 continues to monitor the medium (202). If a sensed temperature is above the reference temperature (204), the solenoid 110 is activated to bleed off the medium (206). As illustrated in FIG. 2, the process continues by monitoring the temperature of the medium (202).

When the system 100 is using the LN₂ for process control, the solenoid 110 will not bleed any LN₂ because the temperature of the medium (which will be LN₂) will be below the reference temperature. Hence, the present invention will only bled off small amounts of LN₂ during periods of idle time. Moreover, embodiments of the present invention control the temperature at the inlet to the system. When the supply line is completely full of GN₂, the embodiments of the present invention will bleed the GN₂ at full power. Once the LN₂ arrives at the inlet (input tube 102), the embodiments will only bleed the LN₂ at a rate necessary to maintain it at the input tube 102. Accordingly, embodiments of the present invention provide an efficient and effective bleeding system that is free from operator input. In addition in systems sourced by long LN₂ feed lines, the present invention is critical for performance.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. For example, other systems requiring a medium of a first state could use the above embodiments. Therefore, it is manifestly intended that this invention be limited only by the claims and the equivalents thereof.

1. A LN₂ maintenance system, the maintenance system comprising:
an input sensor adapted to monitor the temperature of the medium in an input tube to a device using the LN₂; and
a solenoid adapted bleed off the medium based on the monitored temperatures.

2. The maintenance system of claim 1, further comprising;
a controller adapted to compare the monitor temperatures with a reference temperature and active the solenoid when the monitored temperatures are above the reference temperatures.

3. The maintenance system of claim 1, further comprising:
an exhaust pipe adapted to vent the bled off medium away from the chamber.

4. The maintenance system of claim 1, wherein the medium is one of liquid nitrogen and gas nitrogen.

5. The maintenance system of claim 1, wherein the chamber is a thermal chamber.

6. A liquid nitrogen (LN₂) system, the system comprising:
an input tube to provide a flow of LN₂ to a device;
an input sensor adapted to measure the temperature in the input tube; and
a solenoid adapted to selectively bleed off a medium in the input tube during idle periods of the device based on the measured temperatures.

7. The system of claim 6, further comprising:
a controller in communication with the input sensor, the controller further adapted to control the solenoid.

8. The system of claim 6, further comprising:
an exhaust pipe adapted to vent the bled off medium.

9. The system of claim 6, wherein the medium is one of liquid nitrogen (LN₂) and gas nitrogen (GN₂).

10. A method of maintaining a supply of a medium in a first state, the method comprising:
measuring the temperature of the medium in an input tube;
comparing the measured temperature with a reference temperature; and
when the measured temperature is above the reference temperature, bleeding off the medium in the input tube.

11. The method of claim 10, wherein the medium is one of liquid nitrogen and gas nitrogen.

12. The method of claim 10, wherein measuring the temperature of the medium in an input tube further comprises, measuring a temperature of the input tube.

13. The method of claim 10, wherein bleeding off the medium in the tube further comprises:
activating a solenoid.

14. The method of claim 10, wherein bleeding off the medium in the tube further comprises:
directing the medium through an exhaust tube.

15. The method of claim 10, wherein bleeding off the medium in the tube further comprises:
directing the medium into a device using the medium.

16. The method of claim 1, wherein the reference temperature is the temperature in which the medium turns from a liquid to a gas.

17. The method of claim 1, wherein the reference temperature is the temperature near the temperature in which the medium turns from a liquid to a gas.

18. A liquid nitrogen (LN₂) maintenance system, the system comprising:
a means to automatically bleed off gas nitrogen (GN₂) in an input tube during idle periods of a device using the LN₂ so that the LN₂ is available relatively instantaneously upon activation of the device.

19. The system of claim 18, further comprising:
a means to monitor the temperature in the input tube; and
a means to bleed off the GN₂ based on the monitored temperatures.

20. The system of claim 18, further comprising:
a means to vent the bled off gas away from the device.
